(19) United States
(12) Patent Application Publication
(10) Pub. No.: US 2014/0370980 A1
(43) Pub. Date: Dec. 18, 2014

(54) ELECTRONIC GAMING DISPLAYS, GAMING TABLES INCLUDING ELECTRONIC GAMING DISPLAYS AND RELATED ASSEMBLIES, SYSTEMS AND METHODS

(71) Applicant: Bally Gaming, Inc., Las Vegas, NV (US)

(72) Inventors: Zbigniew Czyzewski, Henderson, NV (US); Todd M. Haushalter, Las Vegas, NV (US)

(21) Appl. No.: 13/919,849

(22) Filed: Jun. 17, 2013

(51) Int. Cl. G07F 17/32

(52) U.S. Cl. CPC G07F 17/3211
USPC 463/31

(57) ABSTRACT

Gaming assemblies comprise a playing surface including at least one screen display. A system projects visual light on the screen display. A radiation source illuminates objects placed over the screen display. A radiation sensor senses at least a portion of the objects placed over the screen display. A control circuit utilizes data from the radiation sensor. Methods of operating gaming tables and wagering game systems may include such gaming assemblies.

### FIELD

Embodiments of the present disclosure relate to electronic gaming displays configured to detect objects placed proximate (e.g., over) a surface of the display, gaming tables including one or more electronic gaming displays and related systems and methods.

### BACKGROUND

Game profitability is influenced strongly by the speed at which a game is played. The speed of a game is based on the number of hands dealt per hour and the number of wagers settled per hour. Even where games may have a relatively high advantage and percentage hold by a casino, if the rate of play is low, then faster games with less advantageous house odds may produce more revenues. The speed of a game can especially be an issue with complex games, such as, for example, Ultimate Texas Hold'em®, in which the dealer is tasked with keeping track of more than one bet, possible optional side bets, ranking hands with seven cards, and resolving bets that may involve a multiplier. More details regarding Ultimate Texas Hold'em® are disclosed in U.S. Patent Publication No. 2012/0280454, the disclosure of which is incorporated herein in its entirety by this reference.

Considering the amount of dealer responsibility in the play of a game, even the very best dealers in the business may be slowed down during a game. The time it takes to accurately deal the card game, resolve the card hands in a game, settle all wagers, facilitate cash-outs, resolve disputes, and handle buy-ins can quickly accumulate into a substantial and costly time frame. In the casino business, time spent on gaming is money. When time is not spent playing the games, money is lost.

In addition to the time element, there are the issues of accuracy. Sometimes players are paid on wagers that should go to the house, or paid less or more than the proper amount of the winning wager warrants, and there are instances when players should be paid and their wagers are forfeited to the house. In addition, there are instances when players are given more chips than they paid for, and there are instances when players and/or dealers cheat the house by capping and/or pinching wagers.

In order to reduce the complexity of the dealer's task, systems have been designed to increase the speed and accuracy of wagering games. An example of one such system is described in U.S. Pat. No. 8,262,475 to Snow et al. (referred to hereinafter as “the Snow system”), the disclosure of which is incorporated herein in its entirety by this reference. The Snow system discloses a chipless and cashless gaming table that operates on credit instead of using traditional gaming chips, speeding up game play by eliminating time the dealer would spend exchanging cash for gaming chips, calculating and paying wins, and increasing hands per hour. This also increases revenue for the casino by increasing play and eliminating dealer error in paying out wins to customers.

Another example of a system designed to increase the speed and accuracy of wagering games includes a bet sensor, which is described in U.S. patent application Ser. No. 13/829,843 to Czyzewski et al., the disclosure of which is incorporated herein in its entirety by this reference. The bet sensor automatically determines the value of a wager placed using a gaming chip, or a stack of gaming chips, eliminating the time spent and human error resulting from manually determining the value of the wager.

### BRIEF SUMMARY

In some embodiments, the present disclosure comprises a method of operating a gaming table, the method comprising projecting with a system an image onto a rear side of a screen display positioned proximate a playing surface of a gaming table to enable viewing of the image on a front side of the screen display. The method may also include illuminating the rear side of the screen display with radiation from a radiation source located at the rear side of the screen display. The screen display is at least partially translucent to the radiation to enable at least a portion of the radiation to reflect from an object placed proximate a front side of the screen display. The method further comprises receiving the at least a portion of reflected radiation at a radiation sensor. In addition, the method includes generating digital data corresponding to the portion of reflected radiation received at the radiation sensor. The method also comprises determining that the object is present on the top side of the screen with a control circuit configured to receive the digital data.

In other embodiments, the present disclosure comprises a gaming assembly comprising a playing surface including at least one screen display. The gaming assembly also includes an image projection system positioned on a rear side of the at least one screen display configured to project an image onto the at least one screen display. The gaming assembly further includes a radiation source positioned on the rear side of the at least one screen display. The radiation source is configured to illuminate at least one object on the at least one screen display with radiation. The gaming assembly additionally includes a radiation sensor configured to capture at least a portion of the radiation that reflects off at least one object on the front side of the at least one screen display, and generate digital data corresponding to the portion of the radiation that reflects off the at least one object. The gaming assembly also includes a control circuit operably coupled to the radiation sensor and configured to utilize the digital data to determine the presence of the at least one object.

In other embodiments, the present disclosure comprises a wagering game system, comprising a gaming table. The gaming table includes a playing surface comprising at least one screen display. The gaming table also includes an image projection system behind the playing surface. The image projection system is configured to project a first player interface corresponding to a first wagering game onto the at least one screen display. The gaming table further includes a radiation source behind the playing surface configured to direct radiation toward the at least one screen display. In addition, the gaming table includes a radiation sensor behind the playing surface configured to generate a digital image from reflected radiation that reflects off of at least one object placed on the screen display. The gaming table also includes a control circuit operably coupled to the radiation sensor and configured to receive digital data corresponding to the digital image from the radiation sensor. The control circuit is also configured to detect the presence of the at least one object.

### BRIEF DESCRIPTION OF THE SEVERAL VIEWS OF THE DRAWINGS

FIG. 1 is a simplified top view of an example of a gaming table configured for detecting objects placed over the gaming table;

FIG. 2 is a simplified side-view of an example screen display for a gaming table;

FIG. 3 is a simplified block diagram of a gaming table including one or more screen display systems;

FIG. 4 is a simplified plan view of the screen display showing a non-limiting example of a player interface for playing blackjack;

FIG. 5 is a simplified plan view of the screen display showing a non-limiting example of a player interface for playing three card poker;

FIG. 6 is a simplified block diagram of a wagering game system; and

FIG. 7 is a simplified flowchart of a method of operating a gaming table.

### DETAILED DESCRIPTION

In the following detailed description, reference is made to the accompanying drawings that form a part hereof, and in which is shown by way of illustration, specific embodiments in which the present disclosure may be practiced. These embodiments are described in sufficient detail to enable those of ordinary skill in the art to practice the present disclosure. It should be understood, however, that the detailed description and the specific examples, while indicating examples of embodiments of the present disclosure, are given by way of illustration only and not by way of limitation. From this disclosure, various substitutions, modifications, additions rearrangements, equivalents thereof, or combinations thereof within the scope of the present disclosure may be made and will become apparent to those of ordinary skill in the art.

In accordance with common practice, the various features illustrated in the drawings may not be drawn to scale. The illustrations presented herein are not meant to be actual views of any particular act in a method of administering a wagering game, apparatus for use in administering a wagering game, or component thereof, but are merely idealized representations that are employed to describe various embodiments of the present disclosure. Accordingly, the dimensions of the various features may be arbitrarily expanded or reduced for clarity. In addition, some of the drawings may be simplified for clarity. Thus, the drawings are not necessarily to scale, and may not depict all of the components of a given apparatus (e.g., device) or all operations of a particular method. Additionally, elements common between figures may retain the same or similar numerical designation. Elements with the same number, but including a different alphabet character as a suffix should be considered as multiple instantiations of substantially similar elements and may be referred generically without an alphabet character suffix. For example, elements 100a, 100b, 100c, may be a device that is instantiated three times and referred to generically as element 100.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It should be understood by a person of ordinary skill in the art that the signal may represent a bus of signals, wherein the bus may have a variety of bit widths and the present disclosure may be implemented on any number of data signals including a single data signal.

The various illustrative logical blocks, modules, circuits, and algorithm acts described in connection with embodiments disclosed herein may be implemented as electronic hardware, computer software, or combinations of both. To clearly illustrate this interchangeability of hardware and software, various illustrative components, blocks, modules, circuits, and acts are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the disclosure described herein.

In addition, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be rearranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions (e.g., software code) on a computer-readable medium. Computer-readable media includes both computer storage media and communication media including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

Elements described herein may include multiple instances of the same element. These elements may be generically indicated by a numerical designator (e.g. 110) and specifically indicated by the numerical indicator followed by an alphabetic designator (e.g., 110a) or a numeric indicator preceded by a “dash” (e.g., 110-1).

The term “dealer,” as used herein, refers to any person who administers a wagering game in any capacity, and should not be understood to be limited to persons who deal cards to players. Likewise, the term “dealer interface” should be understood to include an interface configured for use by any person who administers a wagering game in any capacity.

The term “wagering game,” as used herein, refers to any activity including the placing of wagers. Wagering games may include, but are not limited to, poker, blackjack, bingo, keno, craps, slots, pachinko, baccarat, roulette, betting on sporting events, and other wagering games.

The terms “gaming,” “gambling,” or the like, refer to activities, games, sessions, rounds, hands, rolls, operations, and other events related to wagering games such as web-based games, casino games, card games, dice games, and other games whose outcome is at least partially based on one or more random events (“chance” or “chances”), and on which wagers may be placed by a player. In addition, the words “wager,” “bet,” “bid,” or the like, refer to any type of wagers, bets or gaming ventures that are placed on random events, whether of monetary or non-monetary value. A wager may include money, chips, points, credits, symbols, or other items or representations that may have some value related to a wagering game. Points, credits, and other items or representations of value may be purchased, earned, or otherwise issued prior to beginning the wagering game. In some embodiments, purchased points, credits, or other items of value may have an exchange rate that is not one-to-one to the currency used by the user. Wagers may be placed in wagering games that are “play for pay” as well as “play for fun” (no money).

Various platforms are contemplated that are suitable for implementation of embodiments of wagering games according to the present disclosure. For example, embodiments of wagering games may be implemented such that one or more players may place wagers and engage in game play according to the rules of the wagering games. For example, wagering games may be implemented on gaming tables, which may include physical gaming features, such as physical cards, physical chips, and may include a live dealer and a shuffler or shoe. More specifically, a live dealer may deal physical cards, accept wagers, issue payouts, and perform other administrative functions of game play. Some embodiments may be implemented on electronic devices enabling electronic gaming features, such as providing electronic displays for display of virtual cards, virtual chips, game instructions, pay tables, etc. Electronic devices may control progression of the game, rule enforcement, wager and payout calculations, etc. Some embodiments may include features that are a combination of physical and electronic features.

As previously noted, wagering games may be played as a live casino table card game, as a hybrid casino table card game (with virtual cards or virtual chips), on a multi-player electronic platform. A sample multi-player electronic platform is disclosed in U.S. patent application Ser. Nos. 10/764,827; 10/764,994 (now U.S. Pat. No. 7,661,676, issued Feb. 16, 2010); and Ser. No. 10/764,995, all filed on Jan. 26, 2004, the disclosure of each of which applications is incorporated herein in its entirety by this reference.

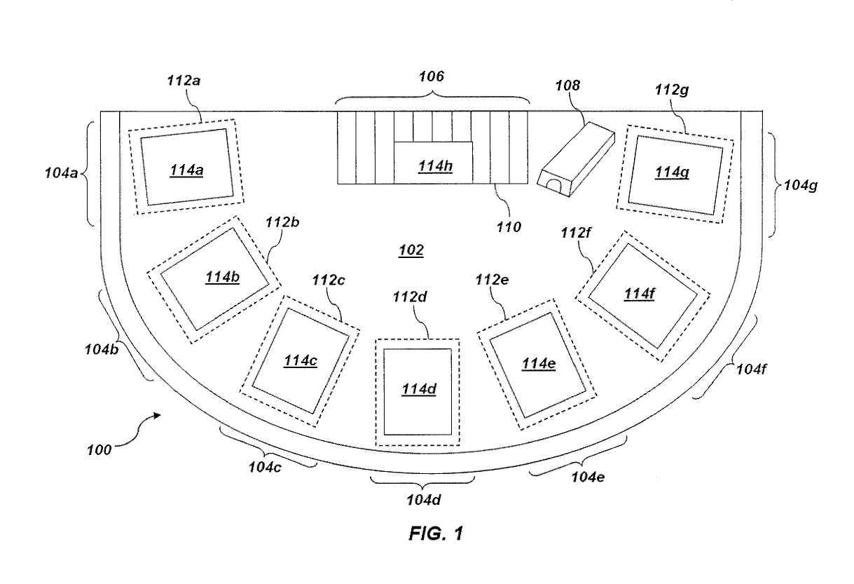

FIG. 1 is a simplified top view of an example of a gaming table 100 configured for detecting objects placed over the gaming table 100. The gaming table 100 may include a playing surface 102, one or more player stations 104a through 104g (generally referred to herein individually as “player station 104,” and together as “player stations 104”), a dealer interface 106, a card handling device 108 and a dealer chip tray 110. Each player station 104 may include a player interface 112a through 112g (generally referred to herein individually as “player interface 112,” and together as “player interfaces 112”), which may be used for displaying game information (e.g., game instructions, input options, wager information, game outcomes, etc.). Each player interface 112 may include at least a portion of a screen display 114a through 114g. For example, each player interface 112 may include a screen display 114a through 114g comprising a rear-projection screen display (e.g., a CRT projection display, an LCD projection display, a digital light Processing® (DLP) screen, etc.).

In a CRT projection system small cathode ray tubes create the image in the same manner that a traditional CRT television does, which is by firing a beam of electrons onto a phosphor-coated screen and then the image is projected to a large screen. Normally three CRT projectors are used, one red, one green and one blue, aligned so the colors mix correctly on the projected image.

In an LCD projection system a lamp transmits light through a small LCD chip made up of individual pixels to create an image. The LCD projector uses mirrors to take the light and create three separate red, green, and blue beams, which are then passed through three separate LCD panels. The liquid crystals are manipulated using electric current to control the amount of light passing through. The lens system takes the three color beams and projects the image.

In a Digital Light Processing (DLP) projection system a DLP projector creates an image using a digital micromirror device (DMD chip), which on its surface contains a large matrix of microscopic mirrors, each corresponding to one pixel in an image. Each mirror can be rotated to reflect light such that the pixel appears bright, or the mirror can be rotated to direct light elsewhere and make the pixel appear dark. The mirror is made of aluminum and is rotated on an axle hinge. There are electrodes on both sides of the hinge controlling the rotation of the mirror using electrostatic attraction. The electrodes are connected to an SRAM cell located under each pixel, and charges from the SRAM cell drive the movement of the mirrors. Color is added to the image-creation process either through a spinning color wheel (used with a single-chip projector) or a three-chip (red, green, blue) projector. The color wheel is placed between the lamp light source and the DMD chip such that the light passing through is colored and then reflected off a mirror to determine the level of darkness. A color wheel consists of a red, green, and blue sector, as well as a fourth sector to either control brightness or include a fourth color. This spinning color wheel in the single-chip arrangement can be replaced by red, green, and blue light-emitting diodes (LED). The three-chip projector uses a prism to split up the light into three beams (red, green, blue), each directed towards its own DMD chip. The outputs of the three DMD chips are recombined and then projected.

As discussed in further detail below, the rear-projection screen display 114 may be configured such that an image is projected on a rear side of the screen display 114 and the image is viewed by a user from a front side of the screen display 114 opposing the rear side. In some embodiments, the screen displays 114a through 114g may be at least substantially flush with the playing surface 102. In some embodiments, the dealer interface 106 may optionally include at least a portion of the screen display 114h, as shown in FIG. 1.

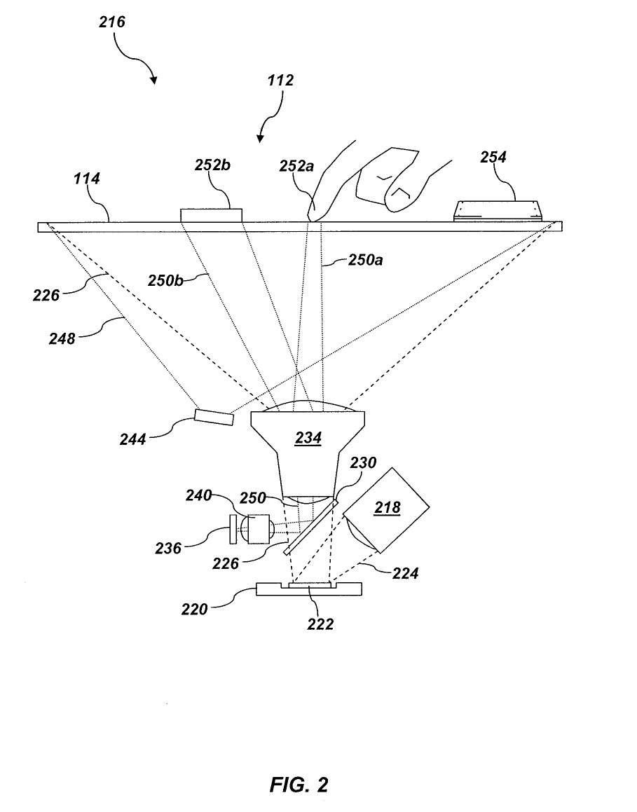

Referring to FIG. 2, the player interface 112 may include a sensor assembly 236 for sensing objects placed over the screen display. For example, the player interface 112 may be integrated with a sensor assembly 236 (e.g., an ultrasound sensing assembly, an ultraviolet sensing assembly, an infrared sensing assembly, etc.) such that objects, such as, for example, playing chips, playing cards, player tracking cards (casino membership ID cards), person's finger, etc. may be detected. The sensor assembly 236 may sense objects by capturing radiation reflected by the object. The radiation may be emitted by a radiation source 244 positioned on the rear side of the screen display 114. The object is sensed when it is placed proximate (e.g., over, on) the screen display 114. The sensor assembly 236 may sense objects placed over the screen display 114 by capturing the radiation reflected by the object. In other embodiments, the objects may be sensed by utilizing resistive touchscreens, capacitive sensing screen displays, acoustic wave touchscreens, infrared grid touchscreens, optical imaging touchscreens, dispersive signal touchscreens (developed by 3M®, detects changes in piezoelectricity in the glass), acoustic pulse touchscreens, and others. The sensor assembly 236 may detect finger touches on the screen display 114 such that the screen display 114 may function as a touch screen device. As the screen display 114 may function as a touch screen, the screen display 114 may present options that a player may select before, during, and after game-play.

Referring again to FIG. 1, in some embodiments, the screen display 114 may occupy substantially the entire playing surface 102. In other embodiments, the screen display 114 may occupy a first portion of the playing surface 102, and a remaining portion of the playing surface 102 may be covered with traditional gaming table cover materials, such as, for example, felt. In still other embodiments, such as the embodiment displayed in FIG. 1, the playing surface 102 may include a plurality of screen displays 114a through 114h, and the remainder of the playing surface 102 may be covered in felt. The playing surface 102 may comprise any of a variety of transparent or translucent glasses or plastics.

The table 100 may be designed in a variety of configurations, such as, a single projection system and a single object detection system for the entire table, a single projection system for the entire table and individual object detection systems for each player, individual projection systems for each player and a single object detection system for the entire table, individual projection systems and individual object detection systems for each player, projection systems shared by two or more players, object detection systems shared by two or more players, etc,

The assemblies, systems, and methods of the present invention may be implemented in a variety of environments, such as, physical playing cards-physical chips, virtual playing cards-physical chips, virtual playing cards-physical chips, virtual playing cards-virtual chips, etc.

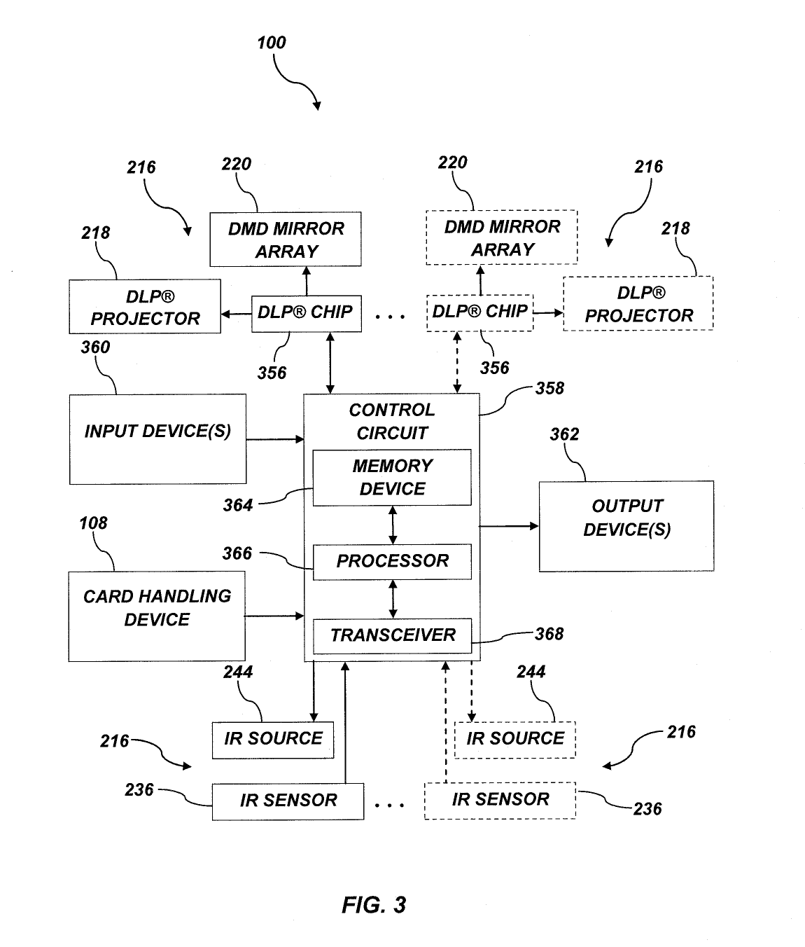

As the player interface 112 has the capability to detect playing chips and playing cards being placed thereon, a control circuit 358 (FIG. 3) operably coupled to the player interface 112 may assist the dealer in keeping track of wagering information, where a playing card is dealt, and other matters relating to game play, and prompt the dealer to take appropriate action.

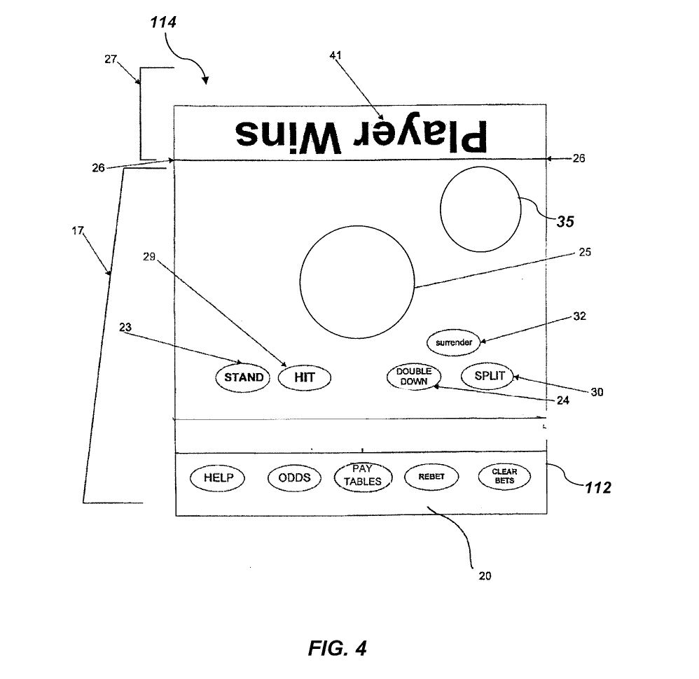

For example, the control circuit 358 may determine whether wagers are made. In an Ultimate Texas Hold'em® wagering game, for example, the control circuit 358 may determine whether an ante wager, a play bet, or side wagers are placed by detecting playing chips placed in a designated area 25 (FIG. 4), such as a betting circle of the screen display 114 dedicated to a particular bet, or on the designated area 25 at a designated time. The control circuit may determine whether a playing card is dealt to a player by detecting the playing card on the screen display 114 in front of the player. The control circuit 358 may also determine how many players are participating in a wagering game and in which positions the players are playing by detecting objects on the screen display at a particular player position.

The dealer interface may include a chip tray 110 (FIG. 1) such that the dealer may store gaming chips during a wagering game. In some embodiments, the wagering game may utilize physical gaming chips, and the player interface 112 may detect the presence of a gaming chip when a player places a bet with the gaming chip on the display screen 114. In other embodiments, the dealer may cash players in and out of the wagering game, and the wagering game may be played using virtual gaming chips displayed on the display screen 114.

For embodiments using physical playing cards, the card handling device 108 (FIG. 1) may be configured to shuffle, read, and/or deliver physical cards for the dealer and players to use during game play, or a card shoe configured to read and/or deliver playing cards that have already been randomized. The card handling device 108 may automatically identify each playing card before dealing the playing card, and send a signal to the control circuit 358 identifying the playing card. More information regarding card handling devices 108 that identify playing cards during game play is disclosed in U.S. Pat. No. 6,460,848 to Soltys, et al., the disclosure of which is hereby incorporated by this reference in its entirety. The player interface 112 that detects a card dealt on a corresponding portion of the display screen 114 may send a signal to the control circuit 358 indicating that the card was dealt to the player at the specific player interface 112. The control circuit 358 may, for example, compare a temporal proximity between signals from the card handling device 108 and the player interface 112 to determine which specific playing cards are dealt to which specific players. The control circuit 358 may, in this way, track all the playing cards in use at the gaming table 100.

For embodiments utilizing virtual cards, such virtual cards may be displayed at the individual display screen 114 of each player interface 112. Common virtual cards may be displayed in a common card area (not shown) of the electronic display 114. The dealer interface 106 may include buttons or touch screen controls for assisting the dealer in administering the wagering game (e.g., similar to the player interfaces 112). As the cards are virtual, the control circuit 358 (FIG. 3) keeps track of the identity and location of each virtual card.

Combining the ability to track virtual or physical cards and the ability to determine whether wagers are made provides the control circuit 358 sufficient information to automate a significant amount of the tasks a dealer must perform during game play. By way of non-limiting example, the control circuit 358 may track progress of the wagering game, determine a winner of the wagering game (if any), determine if any bonuses should apply, and indicate any multipliers that should be applied to payouts.

In some embodiments, the gaming table 100 may display changing pay tables, for example for different bets placed during play. For example, a pay table may be displayed on the display screen 114 and changed during game play and otherwise.

The gaming table 100 of FIG. 1 includes seven (7) player stations 104. The present disclosure, however is not limited to seven player stations. The gaming table may include a single player station 104, or any plurality of player stations 104. Gaming tables 100 including one (1), five (5), seven (7), and nine (9) player stations are common, but any number of player stations 104 are possible.

Further detail of an example of a gaming table and player displays is disclosed in U.S. Patent Application Publication No. 2010/0016050, filed Jul. 15, 2008, and titled “Split Screen on a Chipless Gaming Table,” the disclosure of which is incorporated herein in its entirety by this reference. Although FIG. 1 shows an embodiment including individual discrete player stations, in some embodiments, the entire playing surface 102 may be an electronic display that is logically partitioned to permit game play from a plurality of players for receiving inputs from, and displaying game information to, the players, the dealer, or both. A full table display screen 114 may be used to display elaborate graphics and animations that may attract potential players to the gaming table 100. Also, the display screen 114 may be used to display advertisements during game play and otherwise. In addition, the display screen 114 may be configured to display logos corresponding to casinos, specific wagering games, videos (e.g., live television), and other logos.

FIG. 2 is a simplified side-view of an example display system 216 (e.g., a DLP® system) including a screen display 114, such as the screen displays 114 of FIG. 1. In FIG. 2, outside boundaries of visible light beams are shown with dashed lines, and outside boundaries of radiation beams are shown with dotted lines. In addition to the screen display 114, the DLP system 216 may include an illumination source 218, a digital micromirror device (DMD) 220, a projection lens 234, a radiation source 244 (e.g., an infrared source), and a light sensor (a radiation sensor 236, a radiation lens 240, and an optical filter 230). The illumination source 218 may include one or more high-powered light emitting diodes (LEDs), lasers, metal halide lamps, other light emitters, equivalents thereof, and combinations thereof. The illumination source 218 may also optionally include a color wheel to introduce color if color is not otherwise provided by the illumination source 218.

The illumination source 218 may be configured to illuminate the DMD 220. The DMD 220 may include a mirror array 222 comprising microscopic mirrors (not shown), each microscopic mirror corresponding to a pixel on the screen display 114. The mirrors of the DMD 220 may each be configured to individually move between an on state and an off state. In the on state, a mirror may individually be angled to reflect light 224 from the illumination source 218 to the corresponding pixel on the screen display 114. In the off state, a mirror may individually be angled to reflect light 224 from the illumination source 218 away from the corresponding pixel on the screen display 114. In this way, a given pixel is illuminated in the on state, and not illuminated in the off state.

Reflected light 226 from the mirror array 222 may pass through the optical filter 230 and the projection lens 234. The optical filter 230 may be a dichroic filter configured to transmit the reflected light 226 from the mirror array 222 and reflect radiation. The projection lens 234 may be configured to direct the light 226 from each of the mirrors in the mirror array 222 to the corresponding pixel of the screen display 114.

The radiation source 244 may be, for example, an infrared light emitting diode (LED). The radiation source 244 may be configured to emit light in the infrared spectrum (wavelengths of approximately 700 nanometers to 1000 nanometers). The radiation source 244 may be configured to direct radiation 248 toward the screen display 114. A portion 250a, 250b of the radiation 248 may reflect off objects 252a, 252b positioned over the screen display 114. The portion 250a, 250b of reflected radiation 248 may pass through the projection lens 234, reflect off the optical filter 230, pass through the radiation lens 240, and arrive at the radiation sensor 236.

The radiation sensor 236 may be an infrared camera in some embodiments. The radiation sensor 236 may be configured to detect the presence of a gaming chip and a playing card. The radiation sensor 236 may be capable of differentiating between a gaming chip, a playing card, a finger touch, and other objects on the screen display. The radiation sensor 236 may provide a two-dimensional image of the objects on the screen display 114 to the control circuit 358 (FIG. 3).

In some embodiments, the radiation sensor 236 may provide images with sufficient resolution to identify markings made on objects with radiation sensitive ink. By way of non-limiting example, a unique mark may be made on each playing card, gaming chip, and combinations thereof such that the control circuit 358 (FIG. 3) can identify playing cards and gaming chips placed on the screen display 114. Also by way of non-limiting example, a unique mark may be placed on a player tracking card such that the control circuit 358 may identify a player. When a player is identified, data from the control circuit 358 (e.g., data generated by the player interface 112) may be used to track the gaming activity of the player (e.g., based on the number of hands played by hour, the type of bet placed by the player, the amounts bet by the player, equivalents thereof, combinations thereof, etc.). The control circuit 358 may be utilized to determine appropriate bonuses, advertisements, hints, and other interactions based, at least in part, upon the player's tracked history. More regarding player tracking is disclosed in, for example, U.S. Pat. No. 5,803,808 to Strisower, and U.S. Pat. No. 6,267,671 to Hogan, the disclosures of each of which is incorporated herein by this reference in its entirety.

The screen display 114 may comprise materials that are transparent or translucent to visible light, such as, for example, glass, a plastic or polymer (e.g., acrylic, epoxy, PVC, polycarbonate, ABS, FRP, Nylon™, Mylar™, Delrin, phenolic, polyethylene, polypropylene, Teflon™, etc.), a ceramic, other materials, equivalents thereof, and combinations thereof. By way of non-limiting example, the screen display may be fifty percent (50%) transparent, sixty percent (60%) transparent, seventy percent (70%) transparent, eighty percent (80%) transparent, ninety percent (90%) transparent, one hundred percent (100%) transparent, or any other degree of semi-transparency with regards to the visible spectrum. The screen display 114 may be at least partially or substantially transparent to the radiation frequencies from the radiation source 244 so that the radiation sensor 236 can sense objects on the screen display 114. A special film or tint may be applied to the screen display 114 to improve reflective properties, reduce glare, reduce visibility of components located beneath the screen display 114, enable or improve projection image, enable or improve touchscreen capabilities, etc. By way of non-limiting example, the screen display 114 may optionally include a lenticular lens, a parallax barrier, a Fresnel lens, a diffusion lens, other suitable lenses, equivalents thereof, and combinations thereof. In some embodiment a 3D image may be displayed on the screen display 114.

In some embodiments, at least a portion of the screen display 114 may be smooth. In other embodiments, at least a portion of the screen display 114 may be textured, for example, to discourage gaming chips, playing cards, and other articles, from sliding on the surface of the screen display 114, or for optical effect. The screen display 114 may also optionally include protrusions, protuberances, impressions, depressions, unevenness, intrusions, erections, borders, edges, channels configured, for example, to function as a chip holder 254, an ante chips area, a play chips area, a side bet chips area, a card placement area, a discard area, other device, equivalents thereof, and/or combinations thereof (collectively, uneven areas). Such uneven areas may comprise opaque, transparent or semi-transparent materials. Uneven areas comprising transparent or semi-transparent materials, such as, for example, acrylic, may cause light 226 from the projection lens 234 to refract, reflect, pass through, equivalents thereof, and combinations thereof, creating a pleasing sparkle or glowing effect. Furthermore, in some embodiments, the screen display 114 may be substantially planar. In still other embodiments, the screen display 114 may be curved, or take an irregular shape. For example, the screen display 114 may include a projection (e.g., an angled surface) providing a display for the dealer display (e.g., screen display 114h (FIG. 1)) that is at least partially obscured from the view of the players at the table.

In some embodiments, the screen display 114 may include apertures to enable installation of electronics, or other devices. As the screen display 114 is merely a receptacle to projected light, the screen display may function properly despite punctures, or other effects. In some embodiments, the screen display 114 may be sealed to prevent moisture and/or particles from entering and affecting the optics and/or electronics behind the screen display.

In a configuration where the player interface 112 senses objects placed over the screen display 114 (approximately a two dimensional surface in some embodiments) with a sensor positioned on the rear side of the screen display, the player interface 112 may not be capable of detecting gaming chips stacked on top of each other (e.g., where only the bottom chip is viewable by the sensor). In some embodiments, however, the user interface 112 may be used to determine the amount of a wager if the gaming chips are not perfectly stacked (e.g., where the chips are each placed directly on the screen display 114 or where the chips are partially overlapping). In some embodiments, the screen display 114 may display a guess of the amount of a player's wager, and the player may be asked to confirm or correct the guess. In some embodiments, the screen display 114 may optionally include other devices to improve the accuracy of wager detection, such as, for example, a video camera, a chip RFID reader, a bet sensor that automatically determines the value of a wager placed using stacks of gaming chips. An example of a bet sensor is disclosed in U.S. patent application Ser. No. 13/829,843 to Czyzewski et al., the disclosure of which is incorporated herein in its entirety by this reference.

Another device that utilizes projection technology with a touch screen interface is disclosed in U.S. Pat. No. 7,458,890 to Loose et al., the disclosure of which is hereby incorporated in its entirety by this reference, which patent discloses an interactive touch screen in connection with a transmissive reel slot machine with a superimposed video image.

FIG. 3 is a simplified block diagram of a gaming table 100 including one or more display systems 216. In addition to the one or more display systems 216, the gaming table 100 may include a control circuit 358 operably coupled to one or more input devices 360, one or more output devices 362, a card handling device 108, and the one or more DLP systems 216. The control circuit 358 may include a processor 366 operably coupled to a memory device 364 and a transceiver 368.

The memory device 364 may be configured to store machine-readable commands, digital data, equivalents thereof, and combinations thereof. By way of non-limiting example, the memory device 364 may be a computer readable media, such as read only memory (ROM), a random access memory (RAM), a Flash memory, a magnetic memory, a hard disk drive (HDD), solid-state drive (SSD), equivalents thereof, and combinations thereof. Also by way of non-limiting example, the memory device 364 may store one or more pay tables identifying prizes corresponding to one or more possible event triggers. An event trigger may be an event that may occur during game play, such as a particular card combination, a predetermined number of games played, a predetermined amount of time played, a pot reaching a predetermined level, equivalents thereof, and combinations thereof.

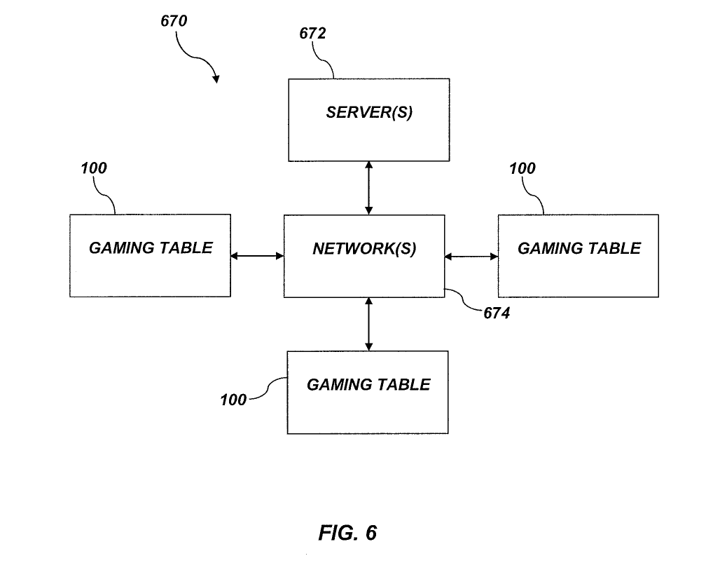

The processor 366 may be configured to execute machine-readable commands stored in the memory device 364. The processor 366 may also be configured to process communications received by the transceiver 368, and cause the transceiver 368 to send communications over the one or more networks 674 (FIG. 6). By way of non-limiting example, the processor 366 may be a complex instruction set computer (CISC) processor, a reduced instruction set computer (RISC) processor, a microcontroller, a field programmable gate array (FPGA), a programmable logic controller (PLC), an application-specific integrated circuit (ASIC), equivalents thereof, and combinations thereof.

Although FIG. 3 displays a single control circuit 358, in some embodiments the gaming table 100 may include a plurality of control circuits 358 to accommodate the computing demands inherent in a gaming table 100 including multiple screen displays 114 and/or multiple object sensing systems.

Each of the one or more display systems 216 may include an illumination source 218 (also referred to herein as “DLP® projector 218”), a DMD 220, a radiation source 244, and a radiation sensor 236, as discussed with respect to FIG. 2. In addition, each display system 216 may comprise a DLP® chip 356 (including an integrated circuit chip, in contrast to a gaming chip used to place wagers) operably coupled to the DMD 220 and the DLP® projector 218. The DLP® chip 356 may include circuitry configured to control the DLP® projector 218 and the DMD 220. In some embodiments, the DLP® projector 218 and the DLP® chip 356 may be integrated into the same package, such as in the DLP® LightCrafter™, which is manufactured by Texas Instruments, Incorporated, of Dallas, Tex. The DLP chip 356 may be operably coupled to the control circuit 358.

In some embodiments, a single DLP® chip 356 may be configured to control more than one DLP® projector 218 or DMD 220. In other embodiments, a single DLP® chip 356 may control a single DLP® projector 218 and a single DMD 220. A single DLP® chip 356, DLP® projector 218, and DMD 220 may be used to illuminate a single screen display 114 (FIG. 1). In addition, a single DLP® chip 356, DLP® projector 218, and DMD 220 may be used to illuminate multiple screen displays 114. Furthermore, more than one DLP® chip 356, DLP® projector 218, and DMD 220 may be used to illuminate a single screen display 114.

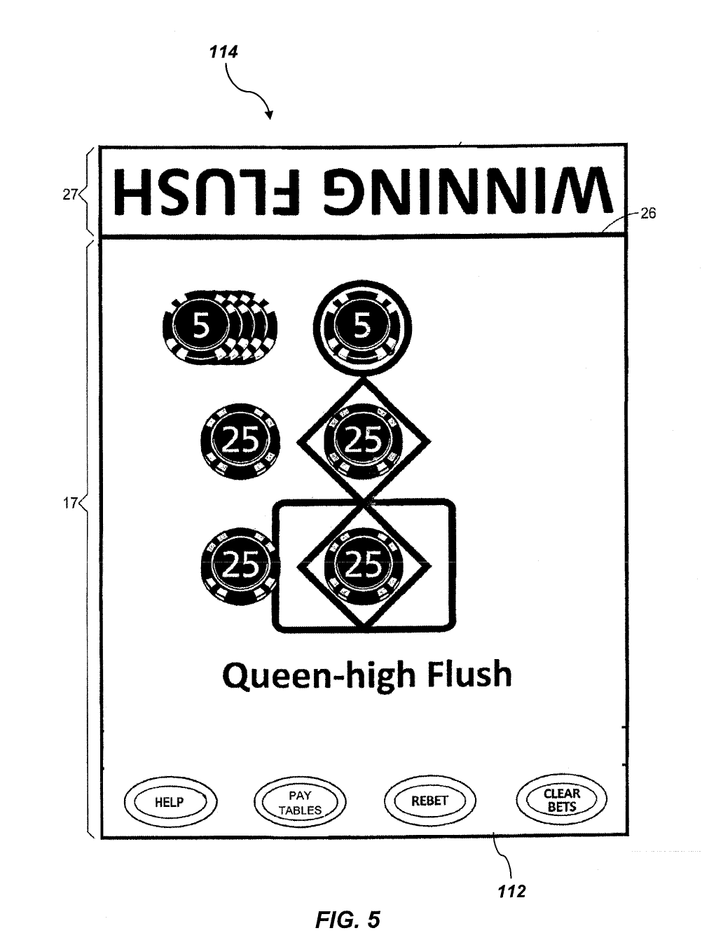

The control circuit 358 may be configured to enable the DLP system 216 to project a player interface 112 (FIGS. 1, 4, and 5) corresponding to any of a plurality of preselected wagering games on the screen display 114. In this way, the gaming table 100 may be used to play any of a number of wagering games. For example, complex wagering games that may especially benefit from the automation the gaming table 100 provides include, for example, Ultimate Texas Hold'em®, Mississippi Stud, and baccarat. Other relatively less complex wagering games may also be played, including three card poker, roulette, and blackjack in some embodiments. The player interface 112 may include at least one player option, which may be selected by touching the player option on the player interface 112. Also, portions of the player interface 112 may be highlighted to assist players or dealers. More detail regarding the player interface 112 is discussed with respect to FIGS. 4 and 5.

The radiation source 244 and the radiation sensor 236 may be operably coupled to the control circuit 358. The control circuit 358 may cause the radiation source 244 to illuminate at least a portion of the one or more screen displays 114 with radiation (e.g., sound waves, ultrasound waves, electro-magnetic waves, radio waves, heat radiation, infrared (IR) radiation, ultraviolet (UV) radiation, visible light, invisible light, alpha radiation, beta radiation, gamma radiation, x radiation, neutron radiation, etc.). The radiation sensor 236 may convert radiation reflected by objects on the surface of the screen display 114 to digital data corresponding to digital images. The radiation sensor 236 may send the digital data corresponding to digital images to the control circuit 358. In some embodiments, the control circuit 358 may be configured to utilize the digital data to identify objects on the surface of the screen display 114. The control circuit 358 may also be configured to utilize the digital data to detect finger touches on the screen display 114, such that the screen display 114 may function as a touch screen assembly. In some embodiments, the resolution of the digital images may be sufficient to distinguish between types of objects placed on the screen display (e.g., playing cards, gaming chips, player fingers, etc.). In other embodiments, the resolution may be sufficient to identify specific instances of the objects (e.g. an amount a chip represents, a suite and rank of a card, etc.).

In some embodiments, the card handling device 108 may be a device configured to shuffle, read, and deliver physical cards for the dealer and players to use during game play. In other embodiments, the card handling device 108 may be a card shoe configured to read and deliver cards that have already been randomized. The card handling device 108 may be configured to send signals to the control circuit 358 informing the control circuit 358 of the identity of all the cards that have been dealt to the players, the dealer, and common use areas. The control circuit 358 may utilize this information to automatically determine game winners, pay table qualification, bonuses, etc.

In some embodiments, the gaming table 100 may be configured to automate at least a part of a task performed by the dealer in response to identification of objects placed on the screen display 114. By way of non-limiting example, the control circuit 358 may automatically determine that a player placed a wager responsive to detecting one or more gaming chips placed on the screen display 114.

Also by way of non-limiting example, the control circuit 358 may receive information identifying each card dealt during a wagering game from the card handling device 108. The control circuit may utilize the radiation source 244 and the radiation sensor 236 to detect each wager placed on the screen display 114. The control circuit may utilize the information from the card handling device and the wager detections to automatically determine a winner of the wagering game and any applicable bonus multipliers. The screen display 114 may indicate the winner and the applicable bonus multipliers. In some embodiments, the dealer may look at the winning players chips and multiply the amount of the winning player's wager by the bonus multiplier indicated by the screen display 114. In other embodiments, the gaming table 100 automatically determines the amount of the wager, and the screen display 114 may display the amount to be paid to the winning player.

By way of non-limiting example, the one or more input devices 360 may include a keyboard, a mouse, a button, a lever, a switch, a button array, a keypad, a touchscreen, a wand, other input devices, equivalents thereof, and combinations thereof. For example, a button may trigger a random number generator (not shown) that may be used in a variety of wagering games. Also by way of non-limiting example, the one or more output devices 362 may include audio speakers, flashing lights, LED lights, LED arrays, electronic displays, LCD displays, CRT displays, projection displays, printers, other output devices, equivalents thereof, and combinations thereof.

FIG. 4 is a simplified plan view of the screen display 114 displaying a non-limiting example of a player interface 112 for playing blackjack. Referring to FIGS. 3 and 4 together, the screen display may be divided into a player area 17 and a dealer area 27 by a split screen line 26. The player area 17 may provide one or more player options, such as, for example, a hit option 29, a stand option 23, a double down option 24, a split option 30, and a surrender option 32. As the gaming table 100 is capable of detecting finger touches with the radiation sensor 236, the screen display 114 may enable the player to input play decisions as well as wagering decisions. In the game of blackjack, “stand” and “hit” instructions can be communicated via the touch screen controls to the control circuit 358, as well as providing a visual instruction 41 (such as, e.g., “Player Wins,” “Hit,” “Stand,” and etc.) to the dealer in the dealer area 27. When the dealer responds to a “hit” command input by the player, the control circuit 358 may receive a card rank and/or suit signal from the card-handling device 108 (FIG. 1), and the control circuit 358 may now know that the dealt card should be associated with the hand dealt to the player position that requested the hit card. Enabling the calling of cards or commands to “split,” “double-down,” “hit,” or “stand” similarly may enable the control circuit 358 to assemble hand information and associate that hand information with a particular display screen 114. The display screen 114 can be equipped with a separate or integrated player tracking system (not shown) of known configurations that enable the game processor to associate win/lose information with a particular player.

A player control area 20 may include other player options, such as, for example a help option, an odds option, a pay tables option, a reset option, and a clear bets option, as illustrated in FIG. 4. The player interface 112 may also include an area designated for placing objects to be recognized, such as, for example, gaming chips, playing cards, and player tracking cards. For example, the player interface 112 may include one or more designated areas 25 for receiving an object such as, for example, one or more gaming chips, playing cards, player tracking cards, etc. In some embodiments, the player interface 112 may include one or more designated areas 35 for receiving an optional bet (e.g., a Royal Match bet in a blackjack game). As previously, discussed, the player interface 112 may sense placement of an object on the screen display 114.

FIG. 5 is a simplified plan view of the screen display 114 displaying a non-limiting example of a player interface 112 for playing Three Card Poker®. A comparison of FIG. 5 to FIG. 4 illustrates the concept encompassed by the disclosure of the display of different player interfaces 112 for different wagering games.

FIG. 6 is a simplified block diagram of a wagering game system 670. The wagering game system 670 may include one or more servers 672 configured to communicate with a plurality of gaming tables 100 through one or more networks 674. The one or more networks 674 (sometimes referred to herein as “networks 674”) may include a network configured to transmit communications between each of the gaming tables 100 and the servers 672, such as by using an internet protocol (IP). The networks 674 may include a wide area network (WAN), a local area network (LAN), a personal area network (PAN), equivalents thereof, and combinations thereof. In some embodiments, the servers 672 may be part of a cloud network. The networks 674 may be configured to communicate with the plurality of gaming tables 100 and the servers 672 wirelessly, through a cable, equivalents thereof, and combinations thereof. Some non-limiting examples of suitable wireless communications may include “Wi-Fi,” BLUETOOTH®, and mobile wireless networks. Some non-limiting examples of suitable cables may include fiber-optic cables, coaxial cables, traditional telephone cables, and Ethernet cables. The networks 674 may support secure communications between gaming tables 100 and the servers 672.

The one or more servers 672 (sometimes referred to herein as “servers 672”) may be one or more computing devices including a control circuit 358 similar to the control circuit 358 of the gaming table 100, and comprising a processor 366 operably coupled to a memory device 364 and a transceiver 368 (FIG. 3). By way of non-limiting example, the servers 672 may comprise a single computing device located in a central location. In other embodiments, the servers 672 may include a plurality of computing devices at the same or separate locations.

To illustrate the idea of multiple servers 672, including one or more computing devices at the same or separate locations, the servers 672 may optionally include a user interaction server, an asset server, a game server, an account server, a deck server, equivalents thereof, and combinations thereof. By way of non-limiting example, the game server may be a game engine, and the user interaction server may communicate with the game server, provide game information to players at a gaming table 100, and enable players to initiate new games, join existing games, and interface with games being played. The asset server may host various media assets (e.g., audio, video, and image files) that may be sent to the gaming tables 100 for presenting wagering games to the players. The account server may verify the existence of funds for wagers, and may be configured to execute debits and credits. The functions performed by the user interaction server, the asset server, the game server, and the account server may be performed by a single computing device, or distributed among a plurality of computing device that communicate with each other through the networks 674.

In some embodiments, the servers 672 may be configured to link at least some of the gaming tables 100 to a progressive jackpot. Examples of systems and methods for administering progressive jackpots are disclosed in U.S. Pat. No. 5,393,067 to Paulsen et al., and U.S. Pat. No. 4,861,041 to Jones et al., the disclosure of each of which is hereby incorporated by this reference in its entirety.

In some embodiments, the gaming tables 100 may detect player tracking cards and send signals to the servers 672 identifying the players. The gaming tables 100 may send player-specific information regarding observed game play to the servers 672. By way of non-limiting example, the player specific information may include a number of hands played, how fast the hands are played, and an average wager. The servers 672 may store the player specific information and utilize the information in determining bonuses, and other interactions with the player. More information concerning player tracking is disclosed in previously referenced U.S. Pat. No. 5,803,808 to Strisower, and U.S. Pat. No. 6,267,671 to Hogan.

Additional features may also be supported by the wagering game system 670, such as hacking and cheating detection, data storage and archival, metrics generation, messages generation, output formatting for different gaming table 100 devices, as well as other features and operations. For example, the wagering game system 670 may include additional features and configurations as described in U.S. patent application Ser. No. 13/353,194, filed Jan. 18, 2012, and application Ser. No. 13/609,031, filed Sep. 10, 2012 both titled “Network Gaming Architecture, Gaming Systems, and Related Methods,” the disclosures of each of which are incorporated herein in their entirety by this reference.

The servers 672 may be configured to interface with social networking websites, such as Facebook®, Twitter® and Pinterest®, over the networks 674. Players may post comments and results of wagering games on social networking websites. Also, casinos may transmit advertisements and information to players that interact with the social networking websites.

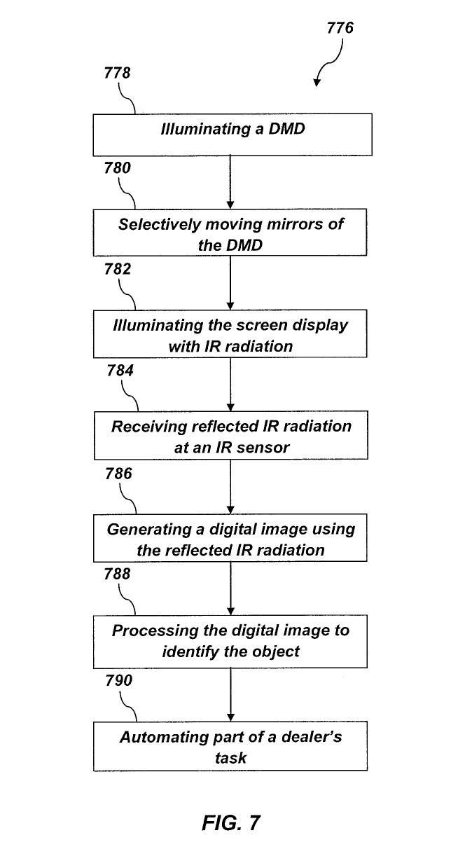

FIG. 7 is a simplified flowchart 776 of a method of operating a gaming table 100. Referring to FIGS. 2, 3, and 7 together, the method may include illuminating a digital micromirror device (DMD) 220 comprising a plurality of mirrors with an illumination source 218 configured to radiate visible light at operation 778. Each of the plurality of mirrors may be selectively moved such that an image is projected toward the rear side of the screen display 114 such and the image is viewable on the front side of the screen display 114 at operation 780. By way of non-limiting example, moving each mirror may comprise individually and selectively rotating each mirror between an on state in which the visible light is reflected to a pixel of the screen display 114 corresponding to the mirror, and an off state in which the visible light is reflected away from the screen display 114. In the off state, the mirror may reflect the visible light to a heat sink in some embodiments.

The rear side of the screen display 114 may be illuminated with a radiation source 244 configured to emit radiation (e.g., infrared radiation) at operation 782. The screen display 114 may be at least partially translucent to radiation such that at least a portion of the radiation reflects from an object placed on a top side of the screen display 114. The method may include receiving the portion of reflected radiation at a radiation sensor 236 at operation 784. By way of non-limiting example, the object on the screen display may include a unique pattern comprising radiation sensitive material on the entire or a portion of the object (e.g., the portion of the object positioned proximate or in contacting with the screen display. In some embodiments, the object may be a gaming chip, and the unique pattern may identify the amount the chip represents. In other embodiments, the object may be a playing card, and the unique pattern may identify the playing card placed on the screen display. In still other embodiments, the unique pattern may be a unique bar code, number, or other identifying pattern on a player tracking device.

The radiation sensor 236 may generate digital data corresponding to an image defined by the portion of reflected radiation received at the radiation sensor 236 at operation 786. By way of non-limiting example, the radiation sensor 236 may be an infrared video camera configured to record video images. A control circuit 358 may process the digital data to identify the object at operation 788. The control circuit 358 may automate or assist in at least a part of a dealer's task responsive to identifying the object at operation 790. By way of non-limiting example, the control circuit 358 may automatically determine that a player placed a wager responsive to detecting one or more gaming chips placed on the top side of the screen display 114.

A sample assembly of the present invention comprises a gaming table having a projection display.

Another sample assembly of the present invention comprises a gaming table having a reflective object detection capability.

Another sample assembly of the present invention comprises a gaming table having a reflective touchscreen capability.

Another sample assembly of the present invention comprises a gaming table having a non-rectangular display.

Another sample assembly of the present invention comprises a gaming table having a display, where at least one side of the display is a partial circle.

A sample method of the present invention comprises the step of projecting with a system an image onto a rear side of a screen display positioned proximate a playing surface of a gaming table to enable viewing of the image on a front side of the screen display.

The sample method above further comprises illuminating the rear side of the screen display with radiation from a radiation source located at the rear side of the screen display, wherein the screen display is at least partially translucent to the radiation to enable at least a portion of the radiation to reflect from an object placed proximate the front side of the screen display.

The sample method above further comprises receiving the at least a portion of reflected radiation at a radiation sensor.

The sample method above further comprises generating digital data corresponding to the portion of reflected radiation received at the radiation sensor.

The sample method above further comprises determining that the object is present on the top side of the screen with a control circuit configured to receive the digital data.

The sample method above further comprises processing the digital data with a control circuit to identify the object, and automating at least a part of a dealer's task responsive to identifying the object.

The sample method above, wherein illuminating the rear side of the screen display with a radiation from a radiation source comprises illuminating the rear side of the screen display with an infrared radiation source.

The sample method above, wherein generating digital data corresponding to the portion of reflected radiation comprises recording a video image with an infrared camera.

The sample method above, wherein projecting the image onto the rear side of the screen display comprises illuminating a digital micromirror device (DMD) comprising a plurality of mirrors with an illumination source configured to radiate visible light.

The sample method above further comprises selectively moving each of the plurality of mirrors such that the image is projected toward the rear side of the screen display.

The sample method above, wherein moving each mirror of the plurality of mirrors comprises individually and selectively rotating each mirror between an on state in which the visible light is reflected to a pixel of the screen display corresponding to the mirror, and an off state in which the visible light is reflected away from the screen display.

The sample method above, wherein receiving the portion of reflected radiation at the radiation sensor comprises receiving the portion of reflected radiation reflected by a unique pattern comprising radiation sensitive material on a portion of the object.

The sample method above further comprises determining with the control circuit that a player placed a wager responsive to detecting at least one gaming chip placed on the front side of the screen display.

The sample method above further comprises receiving information at the control circuit identifying each card dealt during a wagering game from a card handling device.

The sample method above further comprises detecting at least one wager placed by sensing gaming chips placed on the screen display.

The sample method above further comprises utilizing at the control circuit the information from the card handling device and the wager detections to automatically determine a winner of the wagering game and any applicable bonus multiplier.

The sample method above further comprises indicating the winner and any applicable bonus multiplier on the screen display.

A sample gaming assembly of the present invention comprises a playing surface comprising at least one screen display.

The sample gaming assembly above further comprises an image projection system positioned on a rear side of the at least one screen display configured to project an image onto the at least one screen display.

The sample gaming assembly above further comprises a radiation source positioned on the rear side of the at least one screen display, the radiation source configured to illuminate at least one object on the at least one screen display with radiation.

The sample gaming assembly above further comprises a radiation sensor configured to capture at least a portion of the radiation that reflects off at least one object on the front side of the at least one screen display, and generate digital data corresponding to the portion of the radiation that reflects off the at least one object.

The sample gaming assembly above further comprises a control circuit operably coupled to the radiation sensor and configured to utilize the digital data to determine the presence of the at least one object.

The sample gaming assembly above, wherein the image projection system comprises an illumination source configured to radiate visual light.

The image projection system above further comprises a digital micromirror device (DMD) configured to selectively reflect the visual light from the illumination source to the at least one screen display.

The sample gaming assembly above further comprises an automatic card handling device operably coupled to the control circuit.

The sample gaming assembly above, wherein the automatic card handling device is configured to identify each card that is dealt from automatic card handling device and wherein the control circuit is configured to track the location and identity of each card.

The sample gaming assembly above, wherein the control circuit is configured to automatically determine and indicate to a dealer a winning player of a round of a wagering game on the at least one screen display.

The sample gaming assembly above, wherein a front surface of the at least one screen display is at least one of substantially planar and curved.

The sample gaming assembly above further comprises, wherein the control circuit is further configured to cause the image projection system to project a player interface including at least one player option on the screen display.

The sample gaming assembly above further comprises, wherein the control circuit is further configured to highlight various areas of the screen display to assist a player during game play.

The sample gaming assembly above further comprises, wherein the control circuit is further configured to detect a selection of the at least one player option by sensing finger touches on the screen device with the radiation sensor.

The sample gaming assembly above, wherein the radiation source comprises an infrared radiation source, and the radiation sensor comprises an infrared radiation sensor.

A sample wagering game system comprises a gaming table including a playing surface comprising at least one screen display.

The gaming table above further comprises an image projection system behind the playing surface, the image projection system configured to project a first player interface corresponding to a first wagering game onto the at least one screen display.

The gaming table above further comprises a radiation source behind the playing surface configured to direct radiation toward the at least one screen display.

The gaming table above further comprises a radiation sensor behind the playing surface configured to generate a digital image from reflected radiation that reflects off of at least one object placed on the screen display.

The gaming table above further comprises a control circuit operably coupled to the radiation sensor and configured to receive digital data corresponding to the digital image from the radiation sensor and detect the presence of the at least one object.

The sample wagering game system above, wherein the control circuit is configured to cause the image projection system to change from projecting the first player interface corresponding to the first wagering game to projecting a second player interface corresponding to a second wagering game different from the first wagering game.

The sample wagering game system above further comprises a plurality of gaming tables including the gaming table, and at least one server configured to communicate with each of the plurality of gaming tables through at least one network.

The sample wagering game system above, wherein the at least one server is configured to link each of the plurality of gaming tables to a progressive jackpot.

The sample wagering game system above, wherein the radiation sensor is configured to sense a unique identifier on a player tracking card placed on the screen display, monitor the player's activity on the gaming table, and send data indicating the player's activity to the at least one server.

The sample wagering game system above, wherein the at least one server is configured to determine the profitability of a plurality of wagering games played at each of the plurality of gaming tables.

The sample wagering game system above, wherein each of the plurality of gaming tables is configured to detect dealer errors, and send a report of the dealer errors to the at least one server.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of embodiments encompassed by the disclosure as contemplated by the inventors.

1. A method of operating a gaming table, the method comprising:
projecting with a system an image onto a rear side of a screen display positioned proximate a playing surface of a gaming table to enable viewing of the image on a front side of the screen display;
illuminating the rear side of the screen display with radiation from a radiation source located at the rear side of the screen display, wherein the screen display is at least partially translucent to the radiation to enable at least a portion of the radiation to reflect from an object placed proximate the front side of the screen display;
receiving the at least a portion of reflected radiation at a radiation sensor;
generating digital data corresponding to the portion of reflected radiation received at the radiation sensor; and
determining that the object is present on the top side of the screen with a control circuit configured to receive the digital data.

2. The method of claim 1, further comprising processing the digital data with a control circuit to identify the object, and automating at least a part of a dealer's task responsive to identifying the object.

3. The method of claim 1, wherein illuminating the rear side of the screen display with radiation from a radiation source comprises illuminating the rear side of the screen display with an infrared radiation source.

4. The method of claim 3, wherein generating digital data corresponding to the portion of reflected radiation comprises recording a video image with an infrared camera.

5. The method of claim 1, wherein projecting the image onto the rear side of the screen display comprises:
illuminating a digital micromirror device (DMD) comprising a plurality of mirrors with an illumination source configured to radiate visible light; and
selectively moving each of the plurality of mirrors such that the image is projected toward the rear side of the screen display.

6. The method of claim 5, wherein moving each mirror of the plurality of mirrors comprises individually and selectively rotating each mirror between an on state in which the visible light is reflected to a pixel of the screen display corresponding to the mirror, and an off state in which the visible light is reflected away from the screen display.

7. The method of claim 1, wherein receiving the portion of reflected radiation at the radiation sensor comprises receiving the portion of reflected radiation reflected by a unique pattern comprising radiation sensitive material on a portion of the object.

8. The method of claim 1, further comprising determining with the control circuit that a player placed a wager responsive to detecting at least one gaming chip placed on the front side of the screen display.

9. The method of claim 1, further comprising:
receiving information at the control circuit identifying each card dealt during a wagering game from a card handling device;
detecting at least one wager placed by sensing gaming chips placed on the screen display;
utilizing at the control circuit the information from the card handling device and the wager detections to automatically determine a winner of the wagering game and any applicable bonus multiplier; and
indicating the winner and any applicable bonus multiplier on the screen display.

10. A gaming assembly, comprising:
a playing surface comprising at least one screen display;
an image projection system positioned on a rear side of the at least one screen display configured to project an image onto the at least one screen display;
a radiation source positioned on the rear side of the at least one screen display, the radiation source configured to illuminate at least one object on the at least one screen display with radiation;
a radiation sensor configured to capture at least a portion of the radiation that reflects off at least one object on a front side of the at least one screen display, and generate digital data corresponding to the portion of the radiation that reflects off the at least one; object; and
a control circuit operably coupled to the radiation sensor and configured to utilize the digital data to determine the presence of the at least one object.

11. The gaming assembly of claim 10, wherein the image projection system comprises:
an illumination source configured to radiate visual light; and
a digital micromirror device (DMD) configured to selectively reflect the visual light from the illumination source to the at least one screen display.

12. The gaming assembly of claim 10, further comprising an automatic card handling device operably coupled to the control circuit.

13. The gaming assembly of claim 12, wherein the automatic card handling device is configured to identify each card that is dealt from the automatic card handling device and wherein the control circuit is configured to track the location and identity of each card.

14. The gaming assembly of claim 13, wherein the control circuit is configured to automatically determine and indicate to a dealer a winning player of a round of a wagering game on the at least one screen display.

15. The gaming assembly of claim 10, wherein a front surface of the at least one screen display is at least one of substantially planar and curved.

16. The gaming assembly of claim 10, wherein the control circuit is further configured to:
cause the image projection system to project a player interface including at least one player option on the screen display;
highlight various areas of the screen display to assist a player during game play; and
detect a selection of the at least one player option by sensing finger touches on the screen device with the radiation sensor.

17. The gaming assembly of claim 10, wherein the radiation source comprises an infrared radiation source, and the radiation sensor comprises an infrared radiation sensor.

18. A wagering game system, comprising:
a gaming table including:
a playing surface comprising at least one screen display;
an image projection system behind the playing surface, the image projection system configured to project a first player interface corresponding to a first wagering game onto the at least one screen display;
a radiation source behind the playing surface configured to direct radiation toward the at least one screen display;
a radiation sensor behind the playing surface configured to generate a digital image from reflected radiation that reflects off of at least one object placed on the screen display; and
a control circuit operably coupled to the radiation sensor and configured to:
receive digital data corresponding to the digital image from the radiation sensor; and
detect the presence of the at least one object.

19. The wagering game system of claim 18, wherein the control circuit is configured to cause the image projection system to change from projecting the first player interface corresponding to the first wagering game to projecting a second player interface corresponding to a second wagering game different from the first wagering game.

20. The wagering game system of claim 18, further comprising a plurality of gaming tables including the gaming table, and at least one server configured to communicate with each of the plurality of gaming tables through at least one network.

21. The wagering game system of claim 20, wherein the at least one server is configured to link each of the plurality of gaming tables to a progressive jackpot.

22. The wagering game system of claim 20, wherein the radiation sensor is configured to sense a unique identifier on a player tracking card placed on the screen display, monitor the player's activity on the gaming table, and send data indicating the player's activity to the at least one server.

23. The wagering game system of claim 20, wherein the at least one server is configured to determine the profitability of a plurality of wagering games played at each of the plurality of gaming tables.

24. The wagering game system of claim 20, wherein each of the plurality of gaming tables is configured to detect dealer errors, and send a report of the dealer errors to the at least one server.
